(19) United States
(12) Patent Application Publication
(10) Pub. No.: US 2022/0337112 A1
(43) Pub. Date: Oct. 20, 2022

(54) ROTOR OF ELECTRIC MOTOR

(71) Applicant: TEXA DYNAMICS S.R.L., Monastier di Treviso (IT)

(72) Inventor: Bruno VIANELLO, Monastier di Treviso (IT)

(21) Appl. No.: 17/639,637

(22) PCT Filed: Sep. 1, 2020
(86) PCT No.: PCT/IB2020/058118

§ 371 Date: Mar. 2, 2022

(30) Foreign Application Priority Data
Sep. 2, 2019 (IT) 102019000015402

(51) Int. Cl. H02K 1/28; H02K 1/2795

(52) U.S. Cl. CPC H02K 1/28; H02K 1/2795

(57) ABSTRACT

A rotor of electric motor is described comprising:
a disc with a major surface and a rotation axis (X), the major surface of the disc comprising a circular recess in which a circular band or ring of material is arranged, the material being
   capable of magnetizing itself under the action of a magnetizing magnetic field, and
   internally partitioned into areas electrically isolated from one another,
a circular series of permanent magnets arranged about the rotation axis (X) and resting on the circular band,
a grid fixed to the disc for maintaining the position of the magnets on the disc.

This invention refers to a rotor of an electric motor, and to the motor equipped with the rotor.

The invention is directed preferably to an axial-flow electric motor, that is a motor having a stator equipped with windings placed in circular series around an axis. Each winding is used to create a magnetic field, with a polar axis parallel to the rotation axis, through which to make a rotor rotate thanks to the magnetic interaction between the generated magnetic fields and a corresponding circular series of magnetic elements of the rotor.

The rotor and the magnets are subjected to high stresses, and the cyclic changes in magnetic flux affecting the rotor generate eddy currents that degrade the energy efficiency of the motor.

The main object of the invention is to solve or at least mitigate one of the above problems.

The object is achieved by what is stated in the attached claims, wherein advantageous technical characteristics are defined in the dependent claims.

A rotor of an electric motor is proposed, comprising:

a disc, e.g. made of iron or aluminium, with a major surface and a rotation axis, the major surface of the disc comprising a circular recess in which there is arranged a circular band or ring of material which is
capable to magnetize itself under the action of a magnetizing magnetic field and
internally partitioned into electrically isolated areas,

a circular series of permanent magnets arranged about the rotation axis and resting on the circular band,

a grid attached to the disc for maintaining the position of the magnets on the disc.

In this improved rotor of electric motor the permanent magnets resist stress better because they are held by the grid.

In addition, the improved rotor for electric motor has better energy efficiency due to the compactness and uniformity of the material housed in the disc.

In a preferred variant, said internally partitioned material consists of—or comprises—electrically insulated metal laminations. In particular, the laminations may be

rings packed one inside the other concentrically to the rotation axis of the rotor, and/or

one or more spirals wound around the rotor's rotation axis, and/or

plates or laminations arranged side by side in a radial direction with respect to the rotation axis of the rotor or arranged in groups, one next to the other, wherein the laminations lie in one or more planes parallel to the rotation axis.

In a preferred variant, said internally partitioned material consists of—or comprises—granules or powders electrically insulated from each other by an insulating coating, e.g. Somaloy®.

In a preferred variant, the disc has a circular pass-through opening at its center, to facilitate the assembly on the stator and/or to facilitate the mounting on a motor shaft.

In a preferred variant, said circular series of permanent magnets is formed by isosceles-trapezium-shaped magnets, with the larger base facing the periphery of the disc and the smaller base facing the center of the disc.

In a preferred variant, the grid comprises a ring with a circular series of pass-through windows, each configured to receive a magnet and hold it on the disk.

In a preferred variant, each window and each magnet are configured so that their perimeter can be superimposed with shape-fitting, in particular the perimeter of each window comprises an inclined plane complementary to an inclined plane of a magnet.

In a preferred variant, the grid is fixed to the disc with screws, e.g. at the center of the disc.

In a preferred variant, the grid comprises interlocking and/or snap-in elements to be fixed to the disc, e.g. the elements are placed on the periphery of the disc. In particular, the grid comprises a circular series of tabs protruding from its periphery that extend parallel to the rotation axis to fit into corresponding slots of a circular series of slots formed on the periphery of the disc.

In a more preferred variant, the tabs comprise a protruding tooth that can be fitted into a corresponding cavity of one of said slots, to increase the toughness of the grid's attachment to the disc.

Note that the advantageous grid structure and its fixing function for the magnets independently solves the problem of a quick fixing of the magnets to the disc without e.g. adhesives.

Another aspect of the invention is an electric motor comprising a rotor as defined above.

In particular, an aspect of the invention is an electric motor comprising

a rotor as defined above, which is rotatable about a rotation axis;

a shaft that is integral with the rotor and extends along said axis,

a stator comprising
a seat for rotatably supporting the shaft, and
windings placed in a circular series about said axis, each winding for creating a magnetic field with polar axis parallel to the rotation axis through which to make the rotor rotate thanks to the magnetic interaction with the corresponding said circular series of magnetic elements of the rotor.

Preferably, said seat for the shaft is a cylindrical cavity of the stator.

The motor preferably has two identical rotors, as defined above, integral with the same shaft. The rotors rotate adjacent to opposite sides of the stator. In this case the cylindrical cavity of the stator is a pass-through cavity in which the shaft is rotatably housed.

Further advantages will be clear from the following description, which refers to an example of a preferred embodiment of motor in which:

FIG. 1 shows a plan view of a rotor;

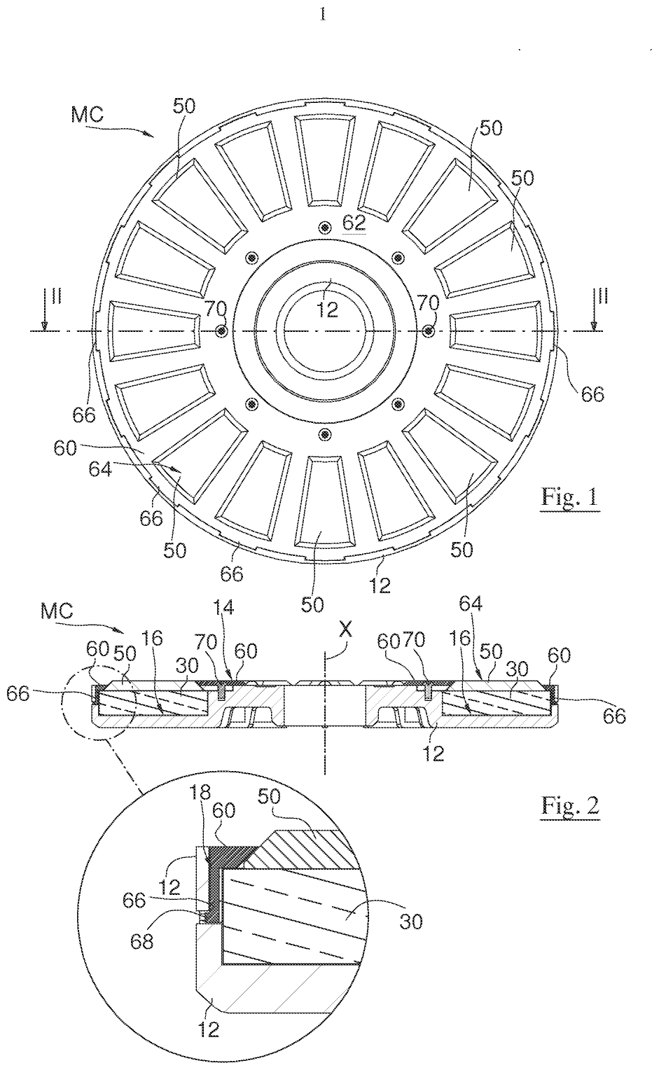

FIG. 2 shows a cross-sectional view of the rotor according to plane II-II.

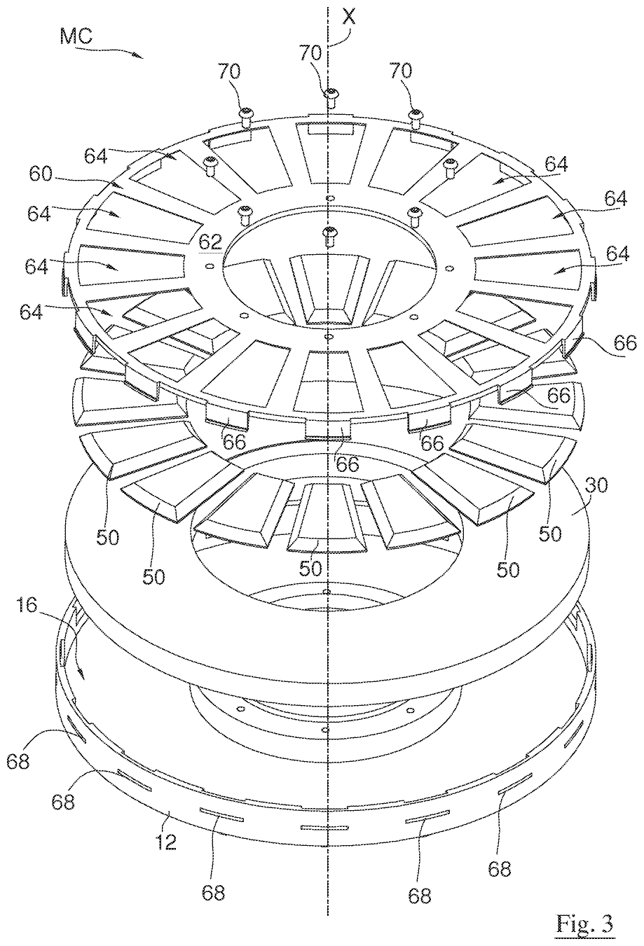

FIG. 3 shows an exploded three-dimensional view of the rotor.

Equal numbers in the figures indicate equal or substantially equal parts; and in order not to crowd the drawings not all equal components are numbered.

With reference to FIG. 1, a rotor MC comprises a support disc 12 which is rotatable about a rotation and symmetry axis X.

The disc 12, e.g. made of aluminium, comprises a major surface 14 comprising a circular recess 16 in which there is arranged a circular band 30 made of material which is internally partitioned into electrically isolated areas. This material may be, for example, a set of metal laminations covered with an insulating layer or paint. For example, the laminations are rings all concentric to the axis X or a spiral concentric to the axis X or laminations arranged radially with respect to a center on the axis S. Or the material may be an agglomerate of granules covered by an insulating layer or paint, e.g. Somaloy.

In the band 30 permanent magnets 50 are placed in a circular series around the axis X. Windings of a stator (not shown) generate magnetic forces that act on the magnets 50 and make the rotor MC rotate.

The magnets 50 preferably have the shape of a flat plate in the shape of an isosceles trapezium, which lies in a plane orthogonal to the axis X and has the larger base facing the periphery of disc 12 and the smaller base facing the center of the disc 12. In this manner, the covering surface of the magnets 50 in the rotor MC increases. However, other shapes are possible.

In particular, the magnets 50 generate a magnetic field with a polar axis parallel to the axis X.

A perforated grid 60, e.g. made of plastic, is fixed to the disc 12 to maintain the position of magnets 50 on the disc 12.

The grid 60 comprises a ring 62 equipped with a circular series of pass-through windows 64 aligned with the recess 16.

The pass-through windows 64 and the magnets 50 have complementary-shaped edges, in particular edges with matching inclined planes, which can overlap to fix the magnets 50 on the band 14.

The grid 60 is fixed to the center of the disc 10 by screws 70 and to the periphery of the disc 12 by a circular series of tabs 66.

The tabs 66 protrude from the periphery of the ring 62 parallel to the axis X and can be snapped into a corresponding circular series of slots 18 made in the periphery of the disc 12, e.g. made in a raised edge of the disc 12. Preferably a or each tab 66 comprises a protruding end tooth 68 for the attachment inside a slot 18.

The band 30 assures to the magnetic field of the magnets 50 a controlled, high-magnetic-permeability closure path, thereby avoiding or limiting the leakage flux and therefore the amount of eddy currents.

1. Rotor of electric motor, comprising:
a disc with a major surface and a rotation axis the major surface of the disc comprising a circular recess in which a circular band or ring of material is arranged, the material being
capable of magnetizing itself under the action of a magnetizing magnetic field, and
internally partitioned into areas electrically isolated from one another,
a circular series of permanent magnets arranged about the rotation axis and resting on the circular band,
a grid fixed to the disc for maintaining the position of the magnets on the disc.

2. Rotor according to claim 1, wherein said internally partitioned material consists of—or comprises—metallic laminations electrically insulated from one another.

3. Rotor according to claim 1, wherein said internally partitioned material consists of—or comprises—granules or powders electrically insulated from one another by an insulating coating.

4. Rotor according to claim 1, wherein said circular series of permanent magnets is formed by magnets in the form of an isosceles trapezium, with the larger base facing the periphery of the disc and the smaller base facing the center of the disc.

5. Rotor according to claim 1, wherein the grid comprises a ring equipped with a circular series of pass-through windows, each configured to receive a magnet and hold it on the disc.

6. Rotor according to claim 5, wherein each window and each magnet are configured so that their perimeter can be overlapped via shape-fitting.

7. Rotor according to claim 6, wherein the perimeter of each window comprises an inclined plane complementary to an inclined plane of a magnet.

8. Rotor according to claim 1, wherein the grid comprises interlocking and/or snap-in elements to be fixed to the disc.

9. Rotor according to claim 8, wherein the grid comprises a circular series of tabs projecting from its periphery and extending parallel to the rotation axis to fit into corresponding slots of a circular series of slots obtained on the periphery of the disc.

10. Rotor according to claim 9, wherein the tabs comprise a protruding tooth which can be fitted into a corresponding cavity of one of said slots.

11. Rotor according to claim 2, wherein said internally partitioned material consists of—or comprises—granules or powders electrically insulated from one another by an insulating coating.

12. Rotor according to claim 3, wherein said circular series of permanent magnets is formed by magnets in the form of an isosceles trapezium, with the larger base facing the periphery of the disc and the smaller base facing the center of the disc.

13. Rotor according to claim 4, wherein said circular series of permanent magnets is formed by magnets in the form of an isosceles trapezium, with the larger base facing the periphery of the disc and the smaller base facing the center of the disc.
